(19) United States
(12) Patent Application Publication
(10) Pub. No.: US 2022/0305837 A1
(43) Pub. Date: Sep. 29, 2022

(54) SECURITY ELEMENT WITH PRINTING INKS THAT VARY UPON ILLUMINATION WITH ELECTROMAGNETIC RADIATION IN THE INFRARED WAVELENGTH RANGE

(71) Applicant: GIESECKE+DEVRIENT CURRENCY TECHNOLOGY GMBH, Munchen (DE)

(72) Inventors: Christian SCHMITZ, Schliersee-Neuhaus (DE); Thomas BODENDIECK, Dresden (DE)

(21) Appl. No.: 17/616,815

(22) PCT Filed: Jun. 9, 2020
(86) PCT No.: PCT/EP2020/025269

§ 371 Date: Dec. 6, 2021

(30) Foreign Application Priority Data
Jun. 13, 2019 (DE) 10 2019 004 229.8

(51) Int. Cl. B42D 25/382; B41M 3/14

(52) U.S. Cl. CPC B42D 25/382; B41M 3/14; B42D 25/29

(57) ABSTRACT

The invention relates to a security element for application to a surface of a valuable document or at least partial embedding into a substrate of the valuable document, for example a banknote or a passport, wherein the security element consists of a plastics film. According to the invention, at least one printing ink which is transparent in the infrared wavelength range of electromagnetic radiation (referred to hereinafter as IR-transparent printing ink) and has a first reflectance value and at least one printing ink which is absorbent in the infrared wavelength range of electromagnetic radiation (referred to hereinafter as IR-absorbing printing ink) and has a second reflectance value are applied to the plastics film of the security element, the separation between the first and second reflectance values being at least 40%.

The invention relates to a security element for application onto a surface of a document of value or at least partial embedding into a substrate of the document of value, for example a bank bill or a passport, the security element consisting of a plastic film.

Security elements of the species, for example security threads for passport papers, are produced in the prior art as so-called country code threads with a flag and a negative or positive text by intaglio printing, UV offset or digital printing on a plastic substrate. In addition, these security threads may be provided with fluorescence. For the text (negative or positive), the same printing ink with the same properties is respectively used.

As further security elements of the species, security films that are applied onto the surface of the substrate of a bank bill are for example known. In the case of second-generation Euro bank bills, these security films extend from the upper edge to the lower edge of the bank bills and cover a hole in the bank bills.

A printing ink that absorbs in the infrared wavelength range of electromagnetic radiation, comprising at least one boride that absorbs radiation in the wavelength range of from 800 nm to 2500 nm, is known from DE 102008049595 A1. This IR-absorbent printing ink is invisible to the naked eye in daylight and is visible under IR light.

The object of the invention is therefore to refine a security element of the species so that the disadvantages of the prior art are overcome and the protection against forgery is further increased.

This object is achieved by the features of the independent claims. The dependent claims relate to refinements of the invention.

According to the invention, at least one printing ink that is transparent in the infrared wavelength range of electromagnetic radiation (referred to below as an IR-transparent printing ink), having a first remission value, and at least one printing ink that is absorbent in the infrared wavelength range of electromagnetic radiation (referred to below as an IR-absorbent printing ink), having a second remission value, are applied onto the plastic film of the security element, the difference between the first and second remission values being at least 40%.

The wavelength of the electromagnetic radiation in the infrared wavelength range for the IR-transparent and IR-absorbent printing inks to be checked particularly preferably lies in the range of from 700 nm to 1000 nm.

Particularly preferably, the at least one IR-transparent printing ink has a first remission value of >90% and the at least one IR-absorbent printing ink has a second remission value of <50%.

The difference of “at least 40%” between the first and the second remission value, or the remission values of the IR-transparent and IR-absorbent printing inks, exists only during the printing process, or for a freshly printed security feature. During the circulation of a document of value that comprises the security feature, the difference of the remission values of the two printing inks will decrease because of abrasion of the printing ink and incorporation of dirt (particularly in the case of bank bills), and distinguishability under illumination with electromagnetic radiation in the infrared wavelength range will become increasingly difficult. For reliable distinguishing of the printing inks under illumination with electromagnetic radiation in the infrared wavelength range, the difference of the remission values of the two printing inks throughout the entire circulation of a document of value should not fall below 20%. In the case of passport papers in which a security thread is fully embedded in the passport paper, on the other hand, contamination and therefore a decrease in the difference of the two remission values are not to be expected.

The plastic film that the security element according to the invention has as a substrate consists, for example, of polyethylene terephthalate (PET).

In the case of the IR-transparent printing ink, under illumination with electromagnetic radiation in the infrared wavelength range more than 90% of the radiation is reflected. By means of a CCD camera with LED lamps, the IR transparency is usually checked with a filter having a wavelength of 850 nm and 940 nm.

According to the invention, as an additional security feature, the text (negative or positive) or pattern, symbol, etc. is printed with two different printing inks, which differ perceptibly in terms of IR transparency.

Particularly preferably, the printing of an IR-transparent and an IR-absorbent printing ink is carried out by UV offset printing. According to a further embodiment, the checking of the IR transparency is carried out by means of an IR camera.

A particular advantage of the invention is the additional recognition of the authenticity of a document of value, for example of a passport paper, by checking the printing inks under IR illumination. This involves concealed security features, so-called level 2 features or “hidden features”.

By the combination of a plurality of level 2 features (for example shortwave and longwave UV fluorescence; IR transparency and visibility; anti-Stokes), the forgery security may be increased further. Besides the IR-transparent and the IR-absorbent printing ink, the security element according to the invention may also have further printing features, for example fluorescence (full-surface, strip-shaped, monochromatic, polychromatic). Combination of the two IR-transparent and IR-absorbent printing inks with metallizations (Al, Cr, Cu, Ni, etc.) or with pigmented metallic printing inks is likewise also possible.

In addition, by the printing inks used according to the invention, which have for example a poor resistance against solvent, acids, alkalis and/or bleaches, the manipulation security may be increased as a supplement to the chemical security of the substrate or paper.

The at least one IR-transparent printing ink and the at least one IR-absorbent printing ink are particularly preferably a solvent-based, water-based or UV-curable printing ink, or toner, which are printed onto the plastic film of the security element by intaglio printing, digital printing, UV offset printing, screen printing, inkjet printing or flexographic printing.

Printing inks that appear transparent under illumination with electromagnetic radiation in the infrared wavelength range are usually inks comprising dyes, while IR-absorbent printing inks are usually pigmented printing inks. Both full transparency, or visibility, under illumination with electromagnetic radiation in the infrared wavelength range, and also gray levels of reduced transparency, which may be controlled by the amount of absorbing pigment in the printing ink, are possible in this case.

With the aid of IR sensors or IR checking devices (for example an IR camera), it is possible to check the authenticity of the security element by the IR-transparent printing elements not being perceptible but only the IR-absorbent printing elements being perceptible under illumination with electromagnetic radiation in the infrared wavelength range. Under illumination with visible electromagnetic radiation, or light with a wavelength of from about 380 nm to about 750 nm, all the printing elements of the IR-transparent and IR-absorbent printing ink(s) are visible. The IR transparency therefore functions as a hidden feature, information that is entirely readable in visible light vanishing under illumination with electromagnetic radiation in the infrared wavelength range.

The IR-transparent and IR-absorbent printing inks may be printed next to one another or above one another, or may be arranged on opposite sides of the substrate of the security element.

The IR-transparent and IR-absorbent printing inks that have a different coloring or contrast under illumination with electromagnetic radiation in the infrared wavelength range should preferably have the same coloring under illumination with visible electromagnetic radiation. If a plurality of printing inks are used on the security element, either only one printing ink may have IR-absorbent properties and a plurality of printing inks may appear IR-transparent, or vice versa.

If text, symbols, patterns are composed of two printing inks that have the same coloring under illumination with visible electromagnetic radiation but have a different IR transparency, the entire printing image of the two printing inks is perceptible by observation under illumination with visible electromagnetic radiation as if there were one printing ink. Under illumination with electromagnetic radiation in the infrared wavelength range, however, it is perceived that printing elements which have been printed by means of the IR-transparent printing ink are missing, i.e. they are not visible.

According to a further advantageous configuration, positive texts may be printed from two different printing inks with different IR transparency, one text block being perceptible and another text block being transparent, i.e. not visible, under illumination with electromagnetic radiation in the infrared wavelength range.

According to a further advantageous configuration, a positive text consists of the two printing inks that are different in IR transparency, and only individual letters are IR-transparent so that a new text that consists only of the IR-absorbent printing ink is visible.

Patterns, symbols or other elements may likewise consist of an IR-transparent and IR-absorbent printing ink, which are arranged next to one another and in turn give a different pattern under illumination with electromagnetic radiation in the infrared wavelength range.

If the IR-transparent printing ink(s) and the IR-absorbent printing ink(s) are printed above one another, the IR-transparent printing ink(s) should preferably have a darker coloring (preferably black) so that, under illumination with electromagnetic radiation in the infrared wavelength range, the patterns, symbols, text of the IR-absorbent printing ink(s) are perceptible. The IR-absorbent printing ink may in this case have different patterns, symbols than the IR-transparent printing ink. If the printing inks are printed above one another and they have the same coloring, the superimposed positions are perceived by observation with incident light and with transmitted light. Under illumination with electromagnetic radiation in the infrared wavelength range, in turn only the IR-absorbent printing elements are perceptible.

The IR-transparent printing ink(s) may also have fluorescent properties. Under illumination with visible electromagnetic radiation, the printing elements are visible, while under illumination with electromagnetic radiation in the infrared wavelength range the printing elements are not perceptible, and under illumination with electromagnetic radiation in the ultraviolet wavelength range the printing elements fluoresce. The IR-transparent and IR-absorbent printing inks may also have a different coloring under UV light, so that under illumination with visible electromagnetic radiation a pattern, for example a star, is perceptible, although under illumination with electromagnetic radiation in the infrared wavelength range it gives a circle (IR-absorbent printing ink) and under UV light a pattern of two or more fluorescent colors is perceptible. The IR-transparent and IR-absorbent printing inks with different fluorescent properties are in this case arranged next to one another, although they may also be printed above one another.

According to a further advantageous configuration, the arrangement of the IR-transparent and IR-absorbent printing ink(s) is as an arrangement of bits, which is readable by machine or optically as a code. Under illumination with visible electromagnetic radiation, both printing inks are perceptible and the overall code may therefore be checked. Under illumination with electromagnetic radiation in the infrared wavelength range, only the bits of the IR-absorbent printing ink are perceptible and gave a new code. Only when the two encodings under illumination with visible electromagnetic radiation and in the infrared wavelength range are perceived correctly may the document of value be recognized as authentic. The individual bits may also contain patterns, symbols, for example negative texts, which give certain information under illumination with visible electromagnetic radiation and different information under illumination with electromagnetic radiation in the infrared wavelength range.

The security element according to the invention may also consist of a multiplicity of an IR-transparent and an IR-absorbent printing elements, the IR-absorbent printing elements containing patterns or symbols, for example as negative texts, over which an IR-transparent printing ink, preferably with the same coloring, is printed. Under illumination with visible electromagnetic radiation, the patterns or symbols of the IR-absorbent printing ink are not perceptible through the overprinting of the IR-transparent printing ink. Under illumination with electromagnetic radiation in the infrared wavelength range, the IR-transparent printing ink is not visible and the IR-absorbent printing elements with the corresponding patterns or symbols are perceived.

Documents of value for which a security element according to the invention may be used are in particular bank bills, securities, bonds, certificates, credits, checks, high-value admission cards, but also other papers at risk of forgery, such as passports and other identification documents, as well as cards, for example credit or debit cards, the card body of which has at least one layer of a security paper, as well as product security elements such as labels, seals, packaging, folding boxes, package inserts and the like.

The simplified term document of value includes all the above-mentioned materials, documents and product security means.

Information in the context of this invention is a visually perceptible representation configured in the form of a pattern. This may, for example, form an alphanumeric symbol sequence of numbers and/or letters, a graphical depiction, an image, a text or other symbols. Particularly preferably, the information in this case consists of positive and/or negative motifs. In the case of a positive motif, a motif element itself is in this case applied onto the substrate, while in the case of a negative motif the region surrounding the motif element is applied onto the substrate. A positive motif is, for example, a letter printed in a dark color onto the light substrate. A negative motif is, for example, an area which is applied in a dark color onto the light substrate and comprises an unprinted region in the shape of a letter inside the area.

It is to be understood that the features mentioned above and those yet to be explained below may be used not only in the combinations indicated but also in other combinations, without departing from the scope of the present invention, insofar as this is included by the protective scope of the claims.

The advantages of the invention will be explained with the aid of the following exemplary embodiments and the appended figures. The exemplary embodiments represent preferred embodiments, although the invention is in no way intended to be restricted to them. Furthermore, for the sake of better understanding, the representations in the figures are highly schematized and do not reflect the true situation. In particular, the proportions shown in the figures do not correspond to the ratios existing in reality and serve only to improve clarity. Furthermore, the embodiments described in the following exemplary embodiments are reduced to the essential core information for the sake of better comprehensibility. In practical implementation, substantially more complex patterns or images may be used.

In detail:

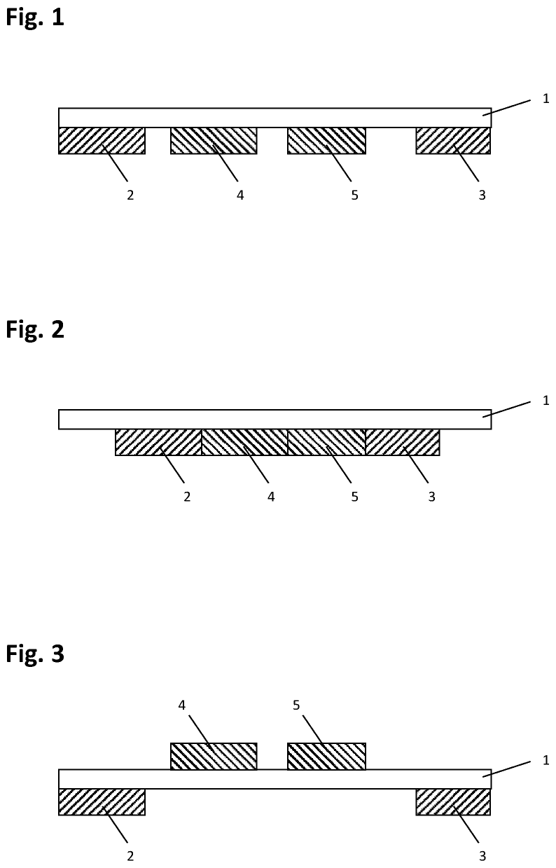

FIG. 1 schematically shows a side view of a security element according to the invention according to a first exemplary embodiment,

FIG. 2 schematically shows a side view of a security element according to the invention according to a second exemplary embodiment,

FIG. 3 schematically shows a side view of a security element according to the invention according to a third exemplary embodiment,

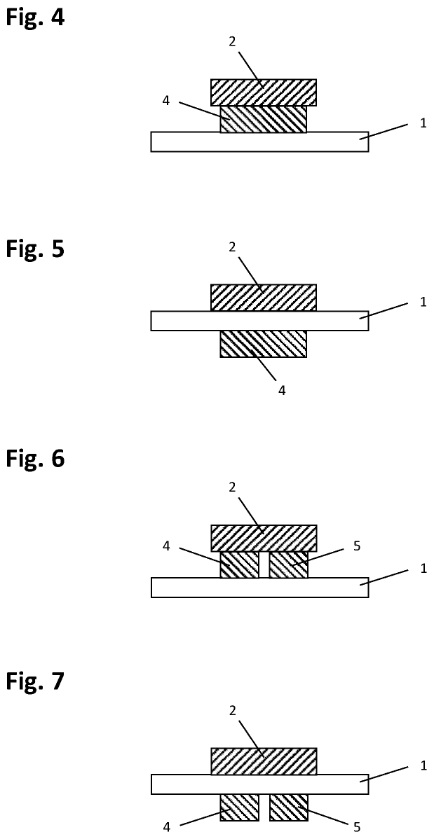

FIG. 4 schematically shows a side view of a security element according to the invention according to a fourth exemplary embodiment,

FIG. 5 schematically shows a side view of a security element according to the invention according to a fifth exemplary embodiment,

FIG. 6 schematically shows a side view of a security element according to the invention according to a sixth exemplary embodiment,

FIG. 7 schematically shows a side view of a security element according to the invention according to a seventh exemplary embodiment,

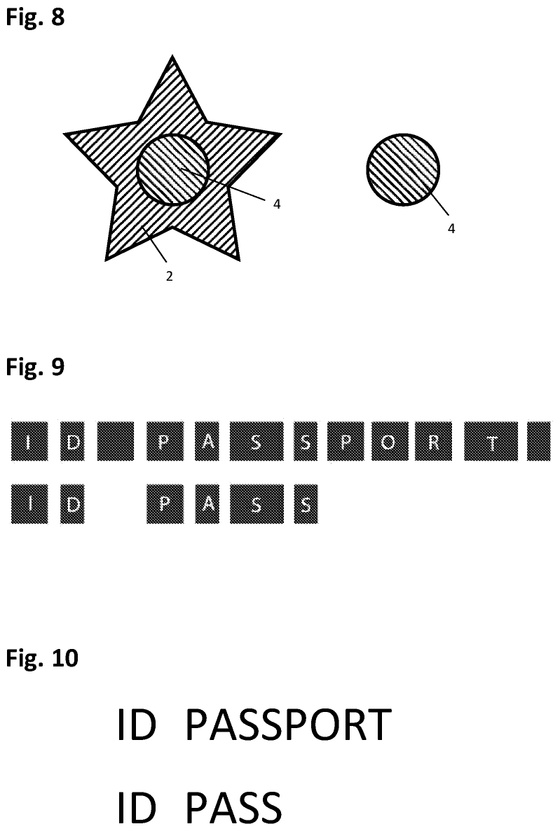

FIG. 8 schematically shows a plan view of a security element according to the invention according to an eighth exemplary embodiment,

FIG. 9 schematically shows a plan view of a security element according to the invention according to a ninth exemplary embodiment,

FIG. 10 schematically shows a plan view of a security element according to the invention according to a tenth exemplary embodiment.

FIG. 1 schematically shows a side view of a security element according to the invention according to a third exemplary embodiment. Two infrared-transparent printing inks 2 and 3 and two infrared-absorbent printing inks 4 and 5 are printed onto a substrate 1, for example a PET film, on one of its sides. The printing inks 2, 3, 4 and 5 are in this case printed at a certain distance from one another. The printing inks 2, 3, 4 and 5 may of course be printed directly next to one another and therefore without a distance from one another, as is shown in FIG. 2.

According to FIG. 3, the infrared-absorbent printing inks 4 and 5 may also be printed onto the opposite side of the substrate 1.

FIG. 4 schematically shows a side view of a security element according to the invention according to a fourth exemplary embodiment, in which an infrared-transparent printing ink 2 is printed fully over an infrared-absorbent printing ink 4 on one side of the substrate 1. According to FIG. 5, the printing inks 2 and 4 may also be printed congruently on opposite side of the substrate 1. Of course, only a partial overlap of the printing inks 2 and 4 is also possible in the exemplary embodiments mentioned above and below.

FIG. 6 schematically shows a side view of a security element according to the invention according to a sixth exemplary embodiment, in which an infrared-transparent printing ink 2 is printed fully over two infrared-absorbent printing inks 4 and 5 on one side of the substrate 1. According to FIG. 7, the printing inks 2, and 4 and 5, may also be printed congruently on opposite side of the substrate 1.

FIG. 8 shows a plan view of a security element according to the invention according to an eighth exemplary embodiment, in which an infrared-absorbent printing ink 4 is printed fully over an infrared-transparent printing ink 2 on one side of a substrate (not represented). The infrared-transparent printing ink 2 in this case forms the information of a five-pointed star, and the infrared-absorbent printing ink 4 forms the information of a circle which is arranged centrally inside the five-pointed star. Under illumination with visible electromagnetic radiation, or light with a wavelength of from about 380 nm to about 750 nm, an observer perceives both the star and the circle, left image in FIG. 8. Under illumination with electromagnetic radiation in the infrared wavelength range, the observer perceives only the circle, right image in FIG. 8.

FIGS. 9 and 10 show a plan view of a security element according to the invention according to a ninth and tenth exemplary embodiment, in which the words “ID” and “PASS” are printed with an infrared-absorbent printing ink and the word “PORT” and the separating symbols, or spaces, are printed with an infrared-transparent printing ink on one side of a substrate (not represented). The individual letters are printed as negative motifs with a light script against a dark background in FIG. 9, and as positive motifs with a dark script against a light background in FIG. 10. Under illumination with visible electromagnetic radiation, an observer perceives the entire lettering “ID PASSPORT”, in each case the upper image. Under illumination with electromagnetic radiation in the infrared wavelength range, the observer perceives only the lettering “ID PASS”, in each case the lower image.

1.-5. (canceled)

6. A security element for application onto a surface of a document of value or at least partial embedding into a substrate of the document of value, for example a bank bill or a passport, the security element consisting of a plastic film,
wherein at least one printing ink that is transparent in the infrared wavelength range of electromagnetic radiation (referred to below as an IR-transparent printing ink), having a first remission value, and at least one printing ink that is absorbent in the infrared wavelength range of electromagnetic radiation (referred to below as an IR-absorbent printing ink), having a second remission value, are applied onto the plastic film of the security element, the difference between the first and second remission values being at least 40%.

7. The security element as claimed in claim 6, wherein the at least one IR-transparent printing ink has a first remission value of >90% and the at least one IR-absorbent printing ink has a second remission value of <50%.

8. The security element as claimed in claim 6, wherein the difference of at least 40% between the first and the second remission value, or the remission values of the IR-transparent and IR-absorbent printing inks, exists only during the printing process, or for a freshly printed security feature, and printing inks does not fall below 20% throughout the entire circulation of a document of value.

9. The security element as claimed in claim 6, wherein the at least one IR-transparent printing ink and the at least one IR-absorbent printing ink are a solvent-based, water-based or UV-curable printing ink, or toner, which are printed onto the plastic film of the security element by intaglio printing, digital printing, UV offset printing, screen printing, inkjet printing or flexographic printing.

10. The security element as claimed in claim 6, wherein the at least one IR-transparent printing ink and the at least one IR-absorbent printing ink have the same coloring under illumination with visible electromagnetic radiation.
